(19) United States
(12) Patent Application Publication
(10) Pub. No.: US 2010/0241514 A1
(43) Pub. Date: Sep. 23, 2010

(54) AUTOMATED PROVISION OF USER FEEDBACK

(75) Inventors: Eyal Ofek, Redmond, WA (US); Yonatan Wexler, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/405,261

(22) Filed: Mar. 17, 2009

(51) Int. Cl. G06Q 30/00; G06F 17/30; G06F 19/00; G06F 15/16

(52) U.S. Cl. 705/14.58; 701/300; 707/E17.108; 707/E17.018; 709/203

(57) ABSTRACT

A system described herein includes an information provider component that uses at least one information providing algorithm to transmit data for display on a display screen of a user, wherein the data corresponds to a geographic location. The system also includes a receiver component that receives an indication from a mobile device of the user that the user has travelled to the geographic location. The system further includes an updater component that causes the at least one information providing algorithm to be updated upon the receiver component receiving the indication.

### BACKGROUND

Search engines are frequently used tools for locating information available by way of the Internet. Information retrieved from a search engine may include web pages, images, documents or other types of information. In operation, a search engine receives a query and outputs a ranked list of search results responsive to receipt of the query. The search engine provides the search results in a ranked order that is based upon determined relevance of a search result with respect to the issued query. Thus, for instance, the search result found to be most relevant to the query is presented first to the user.

Over the last several years an amount of information available by way of the Internet has grown exponentially, thereby causing the job of the search engine to become more difficult. In an effort to continue to provide users with relevant search results, search engines are continually updated in an effort to model user intent. One mechanism used for updating search engines is to analyze feedback pertaining to search results presented to the user. Thus, for instance, a user may issue a query and be provided with a plurality of search results. Upon being provided with such search results, the user may select a search result through use of a pointing and clicking mechanism such as a mouse. Therefore, it is inferred that since the user selected the particular search result, such search result is relevant to the query issued by the user. In other examples, search engines may request explicit feedback from the user.

In some cases, however, the user may click on a provided search result in order to get additional information (e.g., beyond the information displayed in a short summary provided by the search result). After viewing a site corresponding to the selected link, the user may ascertain that such site is not relevant to their query. Thus, the search engine may be updated with inaccurate data.

### SUMMARY

The following is a brief summary of subject matter that is described in greater detail herein. This summary is not intended to be limiting as to the scope of the claims.

Described herein are various technologies pertaining to providing feedback to an information provider based at least in part upon tracked location of a user. For instance, an information provider may be a search engine, an advertising server, a mapping application, or other suitable information provider that is configured to provide information to a user on a computing device.

Pursuant to an example, a user may issue a query to a search engine using a mobile computing device, such as a smart phone or personal digital assistant. The search engine can provide the user with a list of search results, wherein at least one of the search results corresponds to a geographic location. For instance, the search result may be a business that has a certain geographic location (e.g., street address, latitude/longitude coordinates, etc.). The location of the user may then be tracked over time to ascertain whether the user travels to the geographic location. For instance, to protect personal privacy of the user, such tracking can be performed on the client device. In another example, rather than tracking the location of the user over time, an indication can be output when the user arrives at the location (so long as that occurs within a threshold period of time).

If it is determined (e.g., within a threshold window of time from the user being provided with the search result) that the user has traveled to the location corresponding to one of the search results, an indication that the user has traveled to such geographic location can be output by the mobile computing device and received by the information provider. An algorithm used to provide information to users may then be altered based at least in part upon the indication. Furthermore, a provider of the algorithm (e.g., the provider of the search engine) may receive payment from a business if the user travels to the business shown in the list of search results. In another example, the user can be provided with a discount (e.g., from the search engine or the business) if the user travels to the business shown in the list of search results.

While search engines are provided as one example of use of location information as feedback to an information provider, it is to be understood that other embodiments are also contemplated. For instance, the information provider may be an advertisement server that provides an advertisement to a computing device of the user. In another example, the information provider may be a mapping application that transmits travel directions to the user. In the latter example, location of the user can be tracked by the mobile device and an indication can be transmitted to the mapping application if the user diverts from the provided travel directions. Such diversion may be an indication that the travel directions were incorrect, that an accident has taken place, that construction exists, etc.

Other aspects will be appreciated upon reading and understanding the attached figures and description.

### BRIEF DESCRIPTION OF THE DRAWINGS

FIG. 1 is a functional block diagram of an example system that facilitates providing feedback to an information provider.

FIG. 2 is a functional block diagram of an example system that facilitates updating a search engine based upon location data provided by a mobile computing device.

FIG. 3 is a functional block diagram of an example system that facilitates pushing data to a mobile computing device.

FIG. 4 is a functional block diagram of an example system that facilitates providing feedback information from a mobile computing device to a mapping application.

FIG. 5 is a flow diagram that illustrates an example methodology for modifying an information providing algorithm based upon location data provided by a mobile computing device.

FIG. 6 is a flow diagram that illustrates an example methodology for updating a mapping application based at least in part upon location data output by a mobile computing device.

FIG. 7 is a flow diagram that illustrates an example methodology for outputting feedback at a mobile computing device.

FIG. 8 is a flow diagram that illustrates an example methodology for outputting feedback that can be used in connection with updating a mapping application.

FIG. 9 is a flow diagram that illustrates an example methodology for updating an information provider based at least in part upon location information output by a mobile computing device.

FIG. 10 is a flow diagram that illustrates an example methodology for outputting an indication that a user has traveled to a location that corresponds with information provided by an information provider.

FIG. 11 is an example computing device.

### DETAILED DESCRIPTION

Various technologies pertaining to using feedback to update an information provider will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

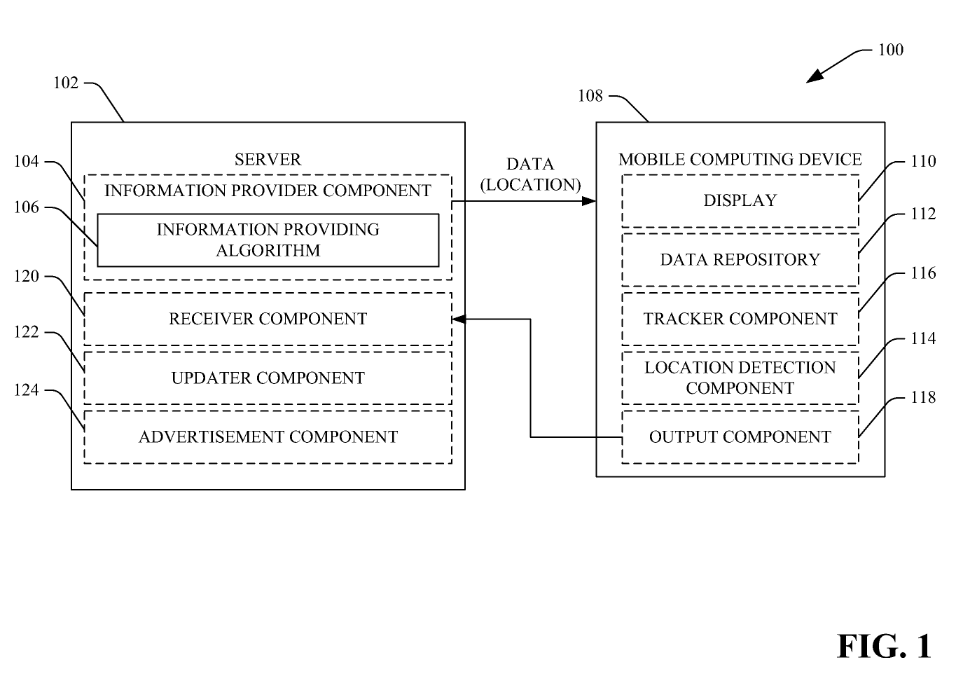

With reference to FIG. 1, an example system 100 that facilitates updating operability of an information provider is illustrated. As used herein, an information provider or information provider component may be any suitable mechanism that uses an information providing algorithm to provide users with information in an automated or semi-automated manner. Thus, for example, an information provider or information provider component may be a search engine that provides users with search results in response to receipt of a user query. In another example, an information provider or information provider component may be an advertisement server that automatically or semi-automatically provides a user with advertising data. In still yet another example, an information provider or information provider component may be a mapping application that provides a user with travel directions upon receipt from the user of an initial point and a destination point. Accordingly, an information providing algorithm may be a search algorithm, a mapping algorithm, etc.

The system 100 includes a server 102 that is accessible to one or more clients by way of a network connection. For instance, the server 102 can be accessed by one or more client devices by way of the Internet. The server 102 includes an information provider component 104 which, as described above, may be a search engine, a mapping application, an advertisement server, etc. The information provider component 104 can include an information providing algorithm 106 that can be used in connection with automatically or semi-automatically outputting data to a client device. In an example, the information providing algorithm 106 may be an algorithm used in a search engine that is configured to locate and/or rank search results in response to receipt of a query from a user. In another example, the information providing algorithm 106 may be an algorithm used to locate a route between a beginning point and a destination point provided by a user. Still further, the information providing algorithm 106 may be used to provide an advertisement to a user, for instance, in response to receipt of data pertaining to the user and/or a query received from the user.

The system 100 also includes a mobile computing device 108, wherein the mobile computing device 108 may be, for instance, a mobile telephone, a multimedia device, a personal digital assistant or other suitable mobile computing device. The mobile computing device 108 may include a display 110 that displays text, graphics, images, videos, etc. to a user. The mobile computing device 108 additionally includes a data repository 112, which can store application data, images, graphics, etc.

Pursuant to an example, the information provider component 104 in the server 102 may be used to output data that is received by the mobile computing device 108. For instance, the data can be output in response to a query initiated at the mobile computing device 108. In another example, the information provider component 104 may output data in response to receipt of a query from another computing device associated with the user. At least some of the data output by the information provider component 104 may pertain to a particular geographic location. For instance, the data may be a list of search results, wherein at least one of the search results references a business that corresponds to a certain address. In another example, the data output by the information provider component 104 may be a travel route between two points.

Data received at the mobile computing device 108 from the information provider component 104 that corresponds to one or more geographic locations may be retained at least temporarily in the data repository 112. For instance, such data may be retained in the data repository 112 for a threshold amount of time and thereafter purged from the data repository 112. Furthermore, the data repository 112 may be configured to retain information that corresponds to the data received from the information provider component 104. For instance, if the information provider component 104 provided the data in response to receipt of a query from the mobile computing device 108 or other device associated with the user, the data repository 112 can store such data together with the query issued by the user. Similarly, if the information provider component 104 outputs travel directions in response to receipt of a beginning point and destination point by the user, the travel directions output by the information provider component 104 as well as the beginning and destination points can be retained in the data repository 112.

The mobile computing device 108 may also include a location detection component 114 that is configured to detect a location of the mobile computing device 108. For instance, a location detection component 114 may be or include global positioning system (GPS) functionality that enables the location detection component 114 to determine geographic location of the mobile computing device 108 as the mobile computing device 108 is ported. Since GPS functionality consumes a relatively large amount of power in mobile devices, the location detection component 114 can intelligently determine when location of the mobile computing device 108 is to be ascertained. For example, if the mobile computing device 108 is not proximate to any locations corresponding to search results, the location detection component 114 can determine location (through use of GPS functionality) relatively infrequently. As the mobile computing device 108 becomes closer to a geographic location corresponding to one or more search results, the location detection component 114 can determine location of the mobile computing device 108 with increasing frequency. To intelligently select when location of the mobile computing device 108 is to be ascertained, the mobile computing device 108 can use a variety of information, such as recent determined locations, average velocity of the mobile computing device 108, direction of travel of the mobile computing device, trends (e.g., the user drives home from work every weekday between certain times), etc.

In another example, the location detection component 114 may include triangulation functionality that allows the location detection component 114 to determine a geographic location of the mobile computing device 108 by triangulating between antennas used to communicate with the mobile computing device 108. Still further, the location detection component 114 may use data corresponding to Wi-Fi access points to determine a geographic location of the mobile computing device 108. In yet another example, the location detection component 114 may receive an image of a current location, analyze such image, and based upon the analysis (e.g., by locating certain landmarks, performing optical character recognition in street signs, . . . ) can determine an approximate geographic location of the mobile computing device 108. In still yet another example, a business may include a local emitter that can uniquely identify the location thereof, and the location detection component 114 can be configured to receive emissions from the local emitter. Thus, the location detection component 114 may use any suitable technology in connection with determining geographic location of the mobile computing device 108.

The mobile computing device 108 may also include a tracker component 116 that analyzes location data determined by the location detection component 114 and contents of the data repository 112. For instance, the tracker component 116 can ascertain whether the mobile computing device 108 is at, near, or travelling towards a geographic location proximate to a geographic location that corresponds with the data received from the information provider component 104. In an example, the data provided by the information provider component 104 may correspond with a business at a certain geographic location. Such geographic location may be retained in the data repository 112 of the mobile computing device 108. The location detection component 114 can be configured to periodically, continuously, or from time to time, output data pertaining to the geographic location of the mobile computing device 108. The tracker component 116 can ascertain that the location detection component 114 has output location data that is similar or substantially similar to the location data contained in the data repository 112.

In another example, the tracker component 116 can ascertain that the user has diverted from a travel route provided by the information provider component 104. For instance, the data provided by the information provider component 104 may be travel directions between two points, and such travel directions may be retained in the data repository 112 of the mobile computing device 108. The location detection component 114 can output location data as the user travels from the first point to the second point. The tracker component 116 can compare contents of the data repository 112 with location data output by the location detection component 114 and can ascertain that the user has diverted from the travel route provided by the information provider component 104.

The mobile computing device 108 may further include an output component 118 that can output an indication that the user has travelling towards or reached a geographic location that is at least proximate to the geographic location that corresponds to the data provided by the information provider component 104. In another example, the output component 118 can output an indication that the user has diverted from the travel route provided by the information provider component 104. The output component 118 may additionally output data pertaining to how the user has diverted from the travel route provided by the information provider component 104. Furthermore, the output component 118 may output the indication after the mobile computing device 108 is proximate to the geographic location that corresponds to the data provided by the information provider component 104 for a threshold amount of time.

The server 102 may include a receiver component 120 that receives the indication output by the output component 118. An updater component 122 may be in communication with the receiver component 120 and may update the information providing algorithm 106 based at least in part upon the received indication from the mobile computing device 108.

The server 102 may also optionally include an advertisement component 124 that can be configured to push advertisements to the mobile computing device 108 in response to receipt of the indication from the output component 118. For instance, information provided by the information provider component 104 may pertain to a particular restaurant. The tracker component 116, by way of a comparison between the known location of the restaurant and location information output by the location detection component 114, can ascertain that the user is travelling towards or is proximate to the restaurant. The output component 118 can output an indication that the user has traveled to the restaurant and such indication may be received by the advertisement component 124. The advertisement component 124 may output advertisements to the mobile computing device 108 pertaining to other restaurants in the area, for instance, or pertaining to coupons for the restaurant to which the user is traveling. For instance, one or more advertisers may wish to participate in a “last chance” auction, wherein advertisers have a final opportunity to influence decisions of the user.

In an example operation of the system 100, the information provider component 104 may be a search engine and the information providing algorithm 106 may be used in connection with providing search results to a user in response to receipt of a query. The user may generate a query that is received by the information provider component 104. For instance, the query may be received from the mobile computing device 108. In response to receipt of the query, the information provider component 104 and the information providing algorithm 106 can output search results that are received at the mobile computing device 108 and displayed on the display 110. Furthermore, the search results and optionally the initiated query can be retained in the data repository 112. For instance, the search results may include a plurality of different businesses that are located at a plurality of different geographic locations.

The tracker component 116 can determine that the user has selected one of the plurality of businesses by comparing location data output by the location detection component 114 and contents of the data repository 112. As the user has traveled to the location of the selected business there is a strong indication that the user has selected such business as her choice when reviewing the search results (thereby indicating that the search result corresponding to the particular business was highly relevant to the query generated by the user). The output component 118 can output an indication that the user has selected the particular business (the search result corresponding to the business) and the updater component 122 can update the information providing algorithm 106 to cause relevancy of such search result to be increased when queries pertaining to the search result are provided to the information provider component 104. Thus, the information providing algorithm 106 can be updated as a function of location-based feedback.

Furthermore, upon determining that the user has selected a business, product, and/or service (based on tracked geographic location of the user), a request can be transmitted to the user to provide a review of the selected business, product, and/or service. In another example, activities of the user may be tracked over time to implicitly determine whether the user was satisfied with the business, product, and/or service (e.g., if the user returns to the location at a later point in time, it can be inferred that the user gives the business, service, and/or product a positive review).

While certain components are shown as residing on the server 102 and other certain components are shown as residing on the mobile computing device 108, it is to be understood that the server 102 and/or the mobile computing device 108 may include components illustrated as being included on the other respective device. For instance, the server 102 may include the tracker component 116 that compares information data output by the information provider component 104 with location data output by the location detection component 114. If the server 102 includes additional capabilities, the user of the mobile computing device 108 may selectively configure such capabilities to alleviate privacy concerns. For instance, the system 100 can be configured to cause the user to be entirely anonymous in connection with data output by the mobile computing device 108. Furthermore, the user may cause location-based data to be deleted (e.g., from the mobile computing device 108 and/or the server 102) after a threshold amount of time or upon user request. It is to be understood that the system 100 is configured to detect relevance of data provided to a user and not configured to monitor travels of the particular user.

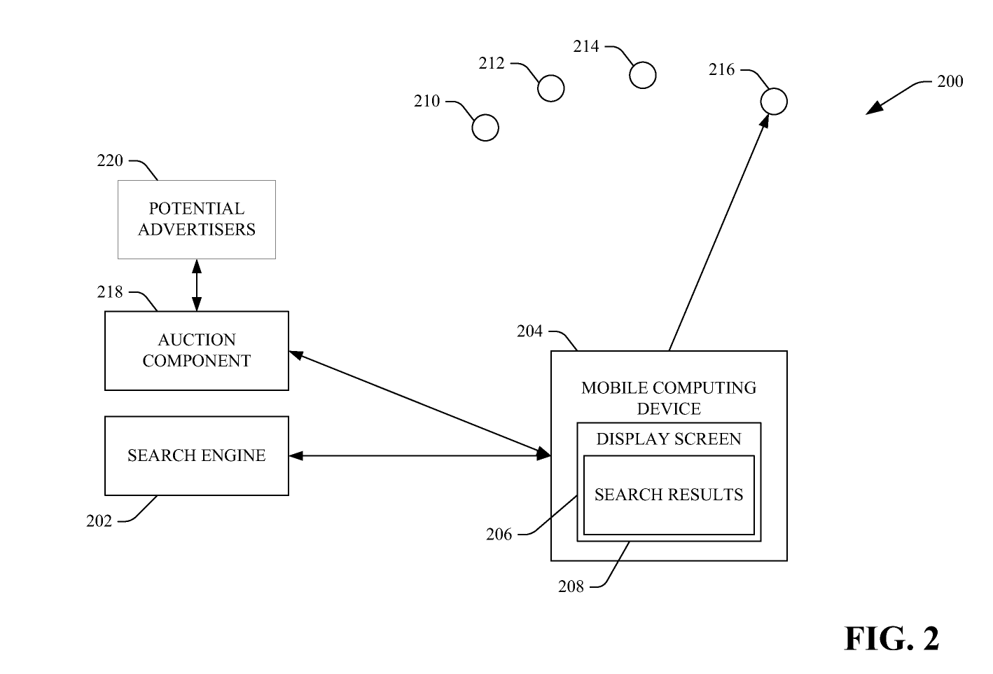

Referring now to FIG. 2, an example system 200 that facilitates providing one or more advertisements (or information) to a user is illustrated. The system 200 includes a search engine 202 that provides search results to a user in response to receipt of a query. For instance, the query can be received from a mobile computing device of the user or other device associated with the user. The system 200 further includes a mobile computing device 204 that comprises a display screen 206. Search results 208 may be displayed to the user by way of the display screen 206. The display screen 206 may also display advertisements or other data. Furthermore, while the system 200 illustrates the search results 208 being displayed on the display screen 206 of the mobile device 204, it is to be understood that the search results 208 may be displayed on a display screen of another computing device of the user. For instance, the search results 208 may be displayed on a personal computer of the user and such data can be transferred to the mobile device 204, for example, by way of synchronizing the mobile computing device 204 with the personal computer.

As shown, the search results 208 provided by the search engine 202 correspond to four different geographic locations 210-216. For instance, the search results 208 may include four different businesses that correspond to the four different locations 210-216. As has been described previously, the tracker component 116 (FIG. 1) can determine that the mobile computing device 204 is travelling towards or proximate to the geographic location 216. Thus, it can be inferred that the user has selected or is about to select the search result (business) that corresponds to the geographic location 216. The output component 118 (FIG. 1) can output an indication that the mobile computing device 204 has selected the search result corresponding to the geographic location 216. Upon receipt of such indication, at least one search algorithm in the search engine 202 may be updated. For instance, the search result corresponding to the geographic location 216 may be given a higher relevance score with respect to all or part of the query initially provided by the user.

The system 200 may also include an auction component 218, wherein the auction component can also receive the indication output by the output component 118 of the mobile computing device 204. Upon receipt of such indication, the auction component 218 may inform potential advertisers 220 that the user is about to select the business corresponding to the geographic location 216. For instance, the auction component 218 may initiate a “last chance” auction amongst the potential advertisers 220. One or more winners of an auction initiated by the auction component 218 can provide advertisements to the mobile computing device 204 in an attempt to cause the user to change their mind with respect to the search result corresponding to the geographic location 216.

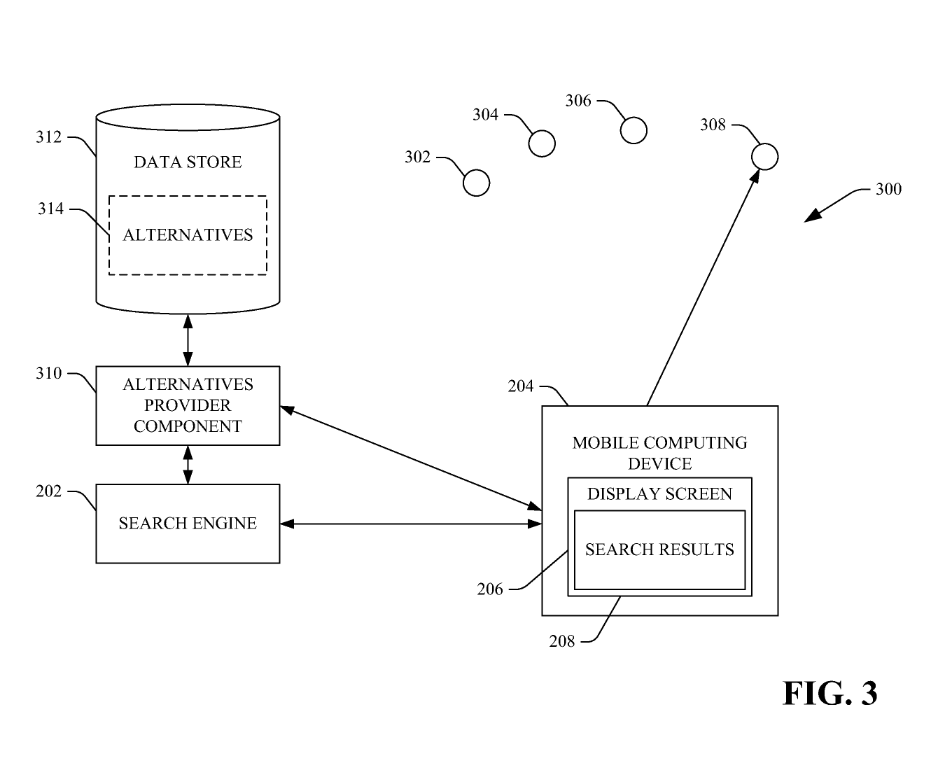

Now referring to FIG. 3, an example system that facilitates providing information to a mobile computing device is illustrated. The system 300 includes the search engine 202, which provides data to the mobile computing device 204, wherein the data is in the form of the search results 208 that are to be displayed on the display screen 206 of the mobile computing device 204. In this example, at least a portion of the data output by the search engine 202 corresponds to a geographic location and additionally corresponds to temporal information. For instance, the data output by the search engine 202 may be movie listings playing at a particular location at certain times. Furthermore, the data output by the search engine 202 may correspond to geographic locations 302-308. For example, a first search result may correspond to the geographic location 302, a second search result may correspond to the geographic location 304, and so on.

As described above, the tracker component 116 (FIG. 1) can ascertain that the user has selected one of the search results provided to the mobile computing device 204 by comparing the geographic location corresponding to the search result and the location(s) of the mobile computing device 204. As shown in FIG. 3, the mobile computing device 204 travels to the geographic location 308, thus indicating that the user has selected the search result corresponding to the geographic location 308. It can be determined, however, that the user is arriving at the geographic location 308 outside a threshold window of time that corresponds to the search result selected by the user. For instance, a movie searched for by the user may be showing at the geographic location 308 at 7 p.m. The user, however, may not arrive at the geographic location until 7:30 p.m. Upon arriving at the geographic location 308, the output component 118 (FIG. 1) can output an indication that the mobile computing device 204 has arrived at the geographic location 308. The search engine 202 may then update at least one search algorithm therein based at least in part upon the received indication from the mobile computing device 204.

The system 300 further includes an alternatives provider component 310 that receives the indication that the user has arrived at the geographic location 308 and compares temporal information corresponding with the search result provided by the search engine 202 with a current time. If the alternatives provider component 310 determines that the mobile computing device 204 has arrived at the geographic location 308 outside a threshold window of time (e.g., 10 minutes, 15 minutes, 20 minutes), then the alternatives provider component 310 can provide the mobile computing device 204 with one or more alternatives that correspond to the geographic location 308. For instance, continuing with the above example the alternatives provider component 310 can provide the mobile computing device 204 with a listing of alternative movies that are playing close to the current time. In another example, the alternatives provider component 310 can provide the mobile computing device 204 with information pertaining to other attractions proximate to the geographic location 308, such that the user can pass time prior to attending the searched for event.

In another example, the alternatives provider component 310 can provide the user with alternatives pertaining to pricing information. For instance, the alternatives provider component 310 can receive an indication that the user is travelling towards a refueling station (e.g., at the geographic location 308). The alternatives provider component 310 can provide the mobile computing device 204 with alternative fueling locations and prices of fuel at such locations. For instance, refueling locations and prices may be retained in the data store 312 as the alternatives 314, and can be updated periodically or from time to time.

The system 300 can also include a data store 312 that includes alternatives 314. Thus, upon receipt of the indication from the mobile computing device 204, the alternatives provider component 310 can analyze alternatives 314 in the data store 312 and intelligently output relevant alternatives to the mobile computing device 204. Such alternatives output by the alternatives provider component 310 may be based at least in part upon known user interests, query that was initially provided by the user, etc.

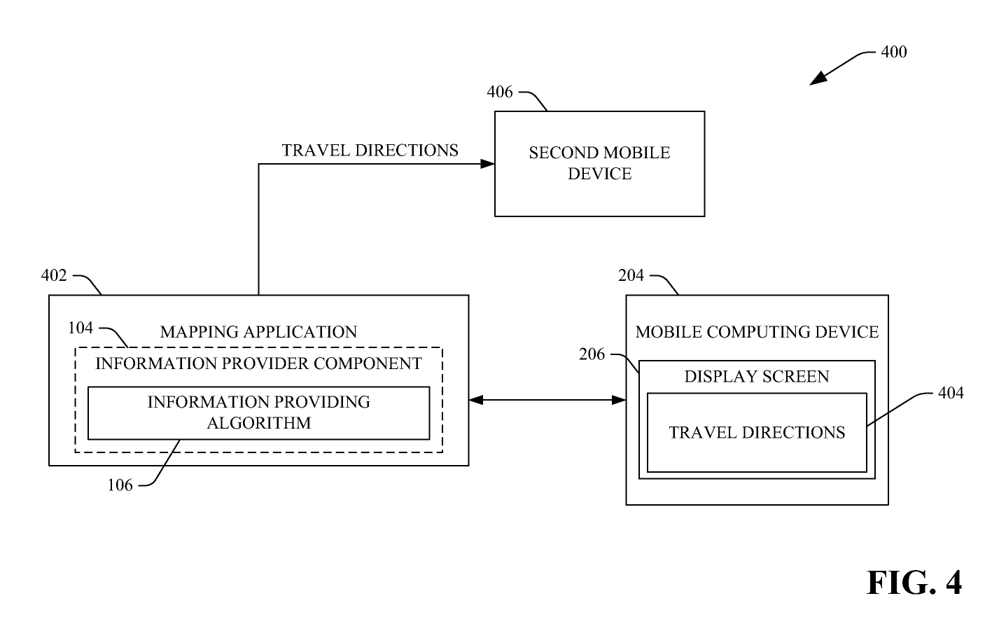

Turning now to FIG. 4, an example system that facilitates updating a mapping application is illustrated. The system 400 includes the mobile computing device 204, which comprises the display screen 206. The system 400 also includes a mapping application 402 that can output street maps, aerial images, travel directions, etc. upon receipt of a request from a user. For instance, a user may request travel directions between a beginning point and a destination point. The mapping application 402 includes the information providing component 104 which uses the information providing algorithm 106 in connection with outputting mapping data to a user.

Pursuant to an example, a user may generate a query for travel directions between a beginning point and a destination point to be viewed on the mobile computing device 204. The mapping application 402 may receive such request, and the information provider component 104 (through use of the information providing algorithm 106) can output travel directions such that the travel directions can be received at the mobile computing device 204. Thus, the display screen 206 can display travel directions 404 output by the mapping application 402.

The tracker component 116 (FIG. 1) can monitor locations of the mobile computing device 204 through use of the location detection component 114. Thus, the tracker component 116 can determine whether the user has followed the travel directions 404 or has for some reason diverted from the travel directions 404. If the tracker component 116 determines that the mobile computing device 204 is not following the provided travel directions 404, it can be inferred that the travel directions 404 were not optimal for the user. For instance, for a particular part of a travel route, the user may know a less congested route. In another example, road construction or detours not known by the mapping application 402 may cause the user to divert from the travel directions 404. In still yet another example, the travel directions 404 may be unclear, thus causing the user to become lost during her journey.

Upon the tracker component 116 determining that the user has diverted from the travel directions 404, the tracker component 116 can track an actual route taken by the user, and the output component 118 can output such route to the mapping application 402. The information providing algorithm 106 may then be updated based at least in part upon the information output by the output component 118. Thus, for instance, if a second user employing a second mobile computing device provides a query to the mapping application 402, the mapping application 402 can use the updated information providing algorithm 106 in connection with providing travel directions to the second mobile computing device 406. For example, if a user of the second mobile computing device 406 is traveling a route where at least a portion of the route is similar to the travel directions 404 output to the mobile computing device 204, the information providing algorithm 106 can modify travel directions provided to the second mobile computing device 406 to take into consideration the actual travel route traveled by the user of the mobile computing device 204.

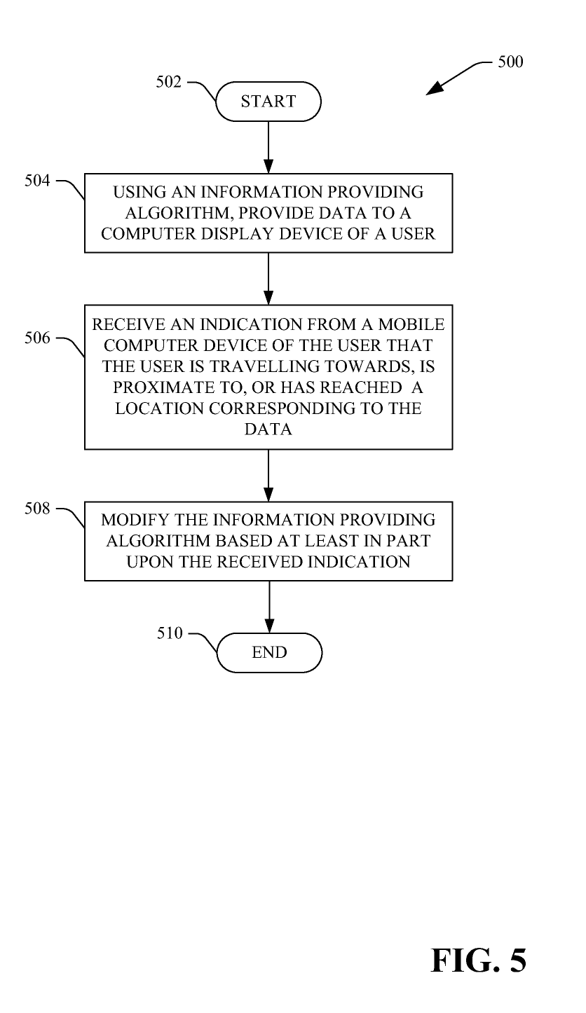

With reference now to FIGS. 5-10, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring now to FIG. 5, an example methodology 500 that facilitates modifying an information providing algorithm based upon a received indication of location is illustrated. The methodology 500 begins at 502, and at 504 data is provided to a computer display device of a user through use of an information providing algorithm. As noted above, the information providing algorithm can be a search algorithm, an algorithm used in connection with determining travel directions between two points, an algorithm used in an advertisement server, etc. Furthermore, the computer display device of the user may reside on any suitable computing device including, but not limited to, a desktop computer, a laptop computer, a mobile computing device such as a smart phone, etc.

At 506 an indication is received from a mobile computing device of the user that the user is travelling towards, is proximate to, or has reached a geographic location corresponding to the data provided by the information providing algorithm. For instance, the data provided by the information providing algorithm may be a plurality of search results, wherein at least one of the search results corresponds to a particular geographic location. It can be inferred that the user has selected the at least one search result if the user travels to the location that corresponds to the search result.

At 508, the information providing algorithm is modified based at least in part upon the indication received at 506. The methodology 500 completes at 510.

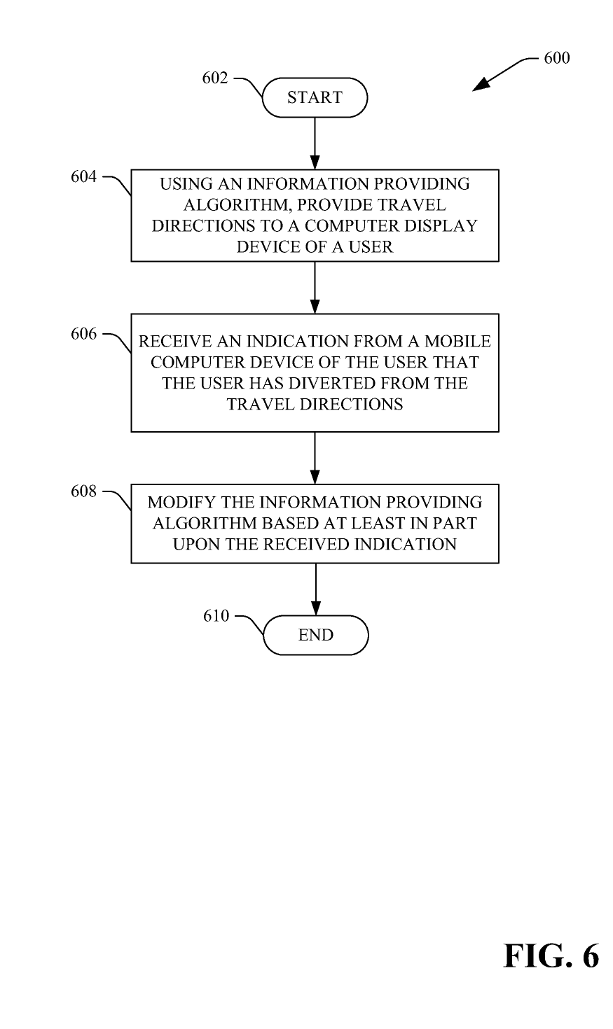

Referring now to FIG. 6, an example methodology 600 for modifying an algorithm used in a mapping application based at least in part upon tracked location of a mobile computing device is illustrated. The methodology 600 starts at 602, and at 604 travel directions are provided to a computer display device of a user through use of an information providing algorithm. For example, such algorithm may be used in connection with determining a travel route that corresponds to a shortest amount of time required to travel between two points.

At 606, an indication is received from a mobile computing device of the user that the user has diverted from the travel directions. For instance, the user may make a turn that is not included in the travel directions but may, nevertheless, continue to the destination point. This can indicate that the travel directions provided to the user were somehow sub-optimal.

At 608, the information providing algorithm is modified based at least in part upon the received indication. The methodology 600 completes at 610.

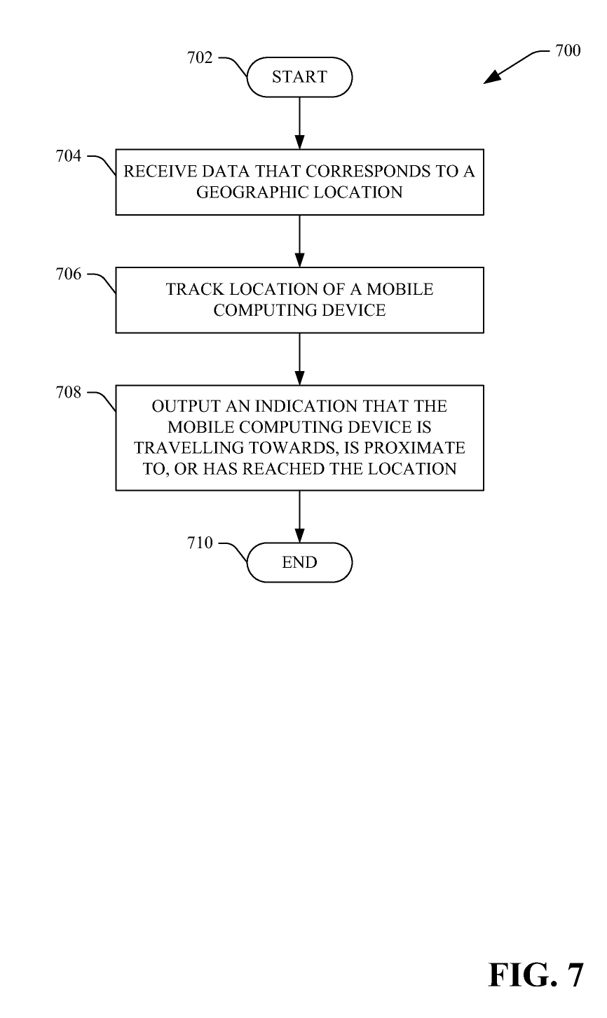

Now referring to FIG. 7, a methodology 700 that can be executed on a mobile computing device such as a personal digital assistant or smart phone is illustrated. The methodology 700 starts at 702, and at 704 data that corresponds to a geographic location is received. For instance, the data may be a search result in a plurality of search results, wherein the search result is a business that has a particular business address.

At 706, location of the mobile computing device is tracked over time. For example, the location can be tracked to determine whether the user travels to the geographic location that corresponds to the data received at 704. Such tracking of location with respect to the received data may occur within a threshold of time of receiving the data.

At 708, an indication is output that the mobile computing device is traveling towards, is proximate to, or has reached the geographic location corresponding to the data received at 704. Thus, in an example, it can be inferred that the user has selected the search results that correspond to the geographic location. The output indication may be received at a search engine and a search algorithm can be updated to cause the search result that corresponds to the geographic location to be assigned a higher relevance score.

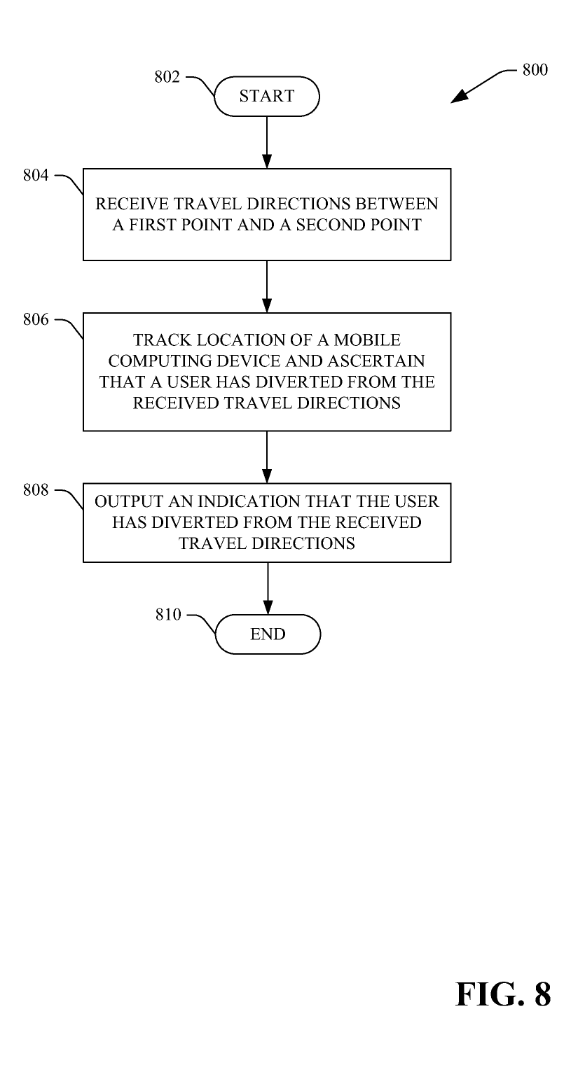

Turning now to FIG. 8, an example methodology 800 that can be executed on a mobile computing device is illustrated. The methodology 800 starts at 802, and at 804 travel directions are received between a first point and a second point. For instance, the travel directions may be received in response to the issuance of a request for travel directions to a mapping application.

At 806, location of the mobile computing device is tracked and it is ascertained that a user of the mobile computing device has diverted from the travel directions received at 804. In an example, the location can be tracked to ensure that the user begins at the first point and ends at the second point but somehow diverts from the route between the first and the second points.

At 808, an indication that the user has diverted from the received travel directions is output. For instance, the output indication can be received by a mapping application and the mapping application can be updated based at least in part upon the output indication. The methodology 800 completes at 810.

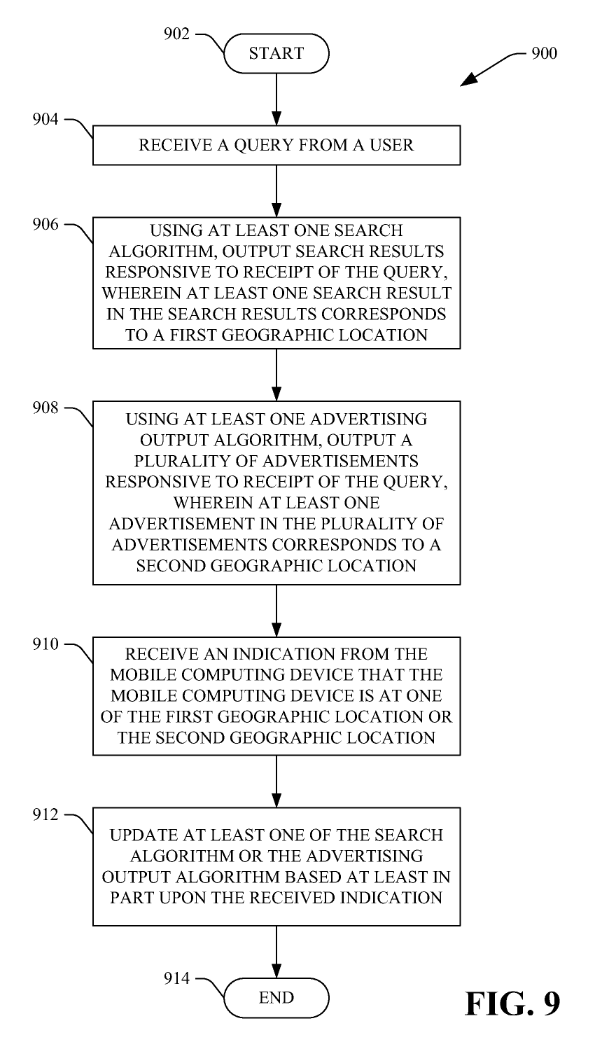

Now referring to FIG. 9, an example methodology 900 that can be executed at a server is illustrated. The methodology 900 starts at 902, and at 904 a query is received from a user. For instance, the query can be received from a mobile computing device of a user and may be a query that is configured for receipt by a search engine.

At 906, search results are output to the mobile computing device responsive to receipt of the query, wherein the search results are output using at least one search algorithm. Furthermore, at least one search result in the search results may correspond to a first geographic location. It is to be understood, however, that additional search results in the provided search results may correspond to various geographic locations.

At 908, a plurality of advertisements are output responsive to receipt of the query, wherein the advertisements are output through use of at least one advertising output algorithm. Furthermore, the advertisements may be output for receipt at the mobile computing device of the user. Additionally, at least one advertisement in the plurality of advertisements can correspond to a second geographic location.

At 910, an indication is received from the mobile computing device that the mobile computing device has traveled to one of the first geographic location or the second geographic location. By receiving such indication it can be inferred that the user was in some way affected by a search result corresponding to the first geographic location or an advertisement corresponding to the second geographic location.

At 912, at least one of the search algorithms or the advertising output algorithm is updated based at least in part upon the received indication. The methodology completes at 914.

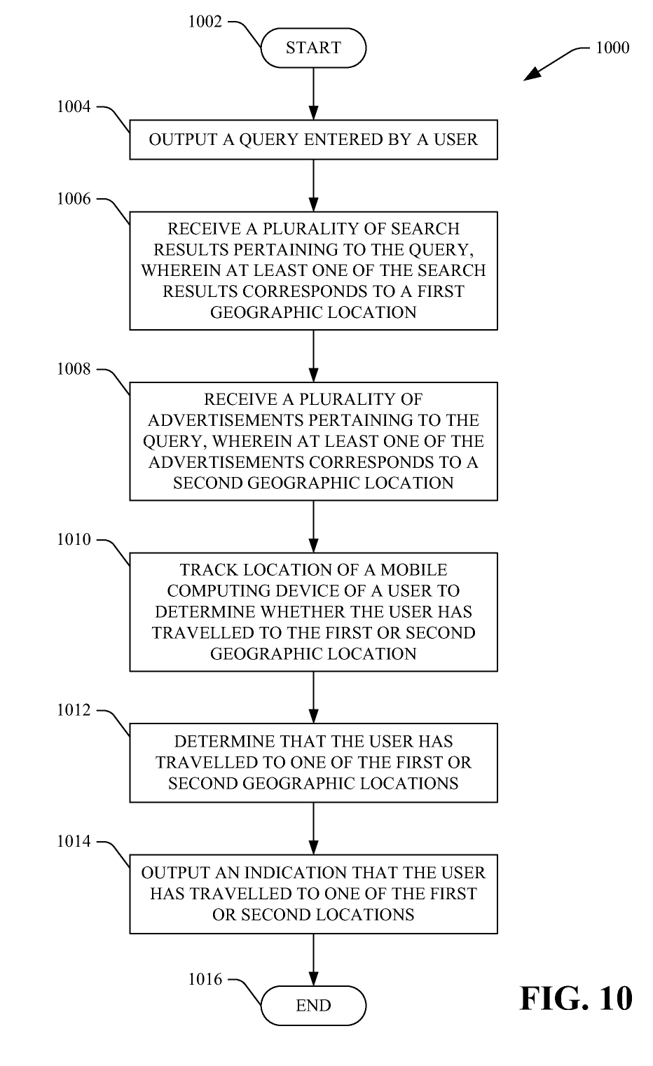

With reference now to FIG. 10, an example methodology 1000 that can be executed on a mobile computing device is illustrated. The methodology 1000 starts at 1002, and at 1004 a query provided to the mobile computing device by a user is output. For instance, the query can be output such that it is to be received by a search engine.

At 1006, a plurality of search results pertaining to the query are received and displayed on a display screen of the mobile computing device. Furthermore, at least one of the search results displayed on the display screen of the mobile computing device can correspond to a first geographic location.

At 1008, a plurality of advertisements pertaining to the query are received and displayed on a display screen of the mobile computing device. Furthermore, at least one of the received advertisements displayed on the display screen of the mobile computing device can correspond to a second geographic location.

At 1010, the location of the mobile computing device of the user can be tracked to determine whether the user has traveled to the first geographic location or the second geographic location. For instance, the location of the mobile computing device may be tracked within a particular threshold window of time such that it can be inferred that there is some relationship between what was displayed to the user and where the user travels.

At 1012, a determination is made regarding whether the user has traveled to one of the first or second geographic locations (and thus has selected a search result corresponding to the first geographic location or an advertisement corresponding to the second geographic location).

At 1014, an indication that the user has traveled to one of the first geographic location or the second geographic location is output, wherein the output indication may be configured for transmittal to a search engine and/or an advertisement server. The methodology completes at 1016.

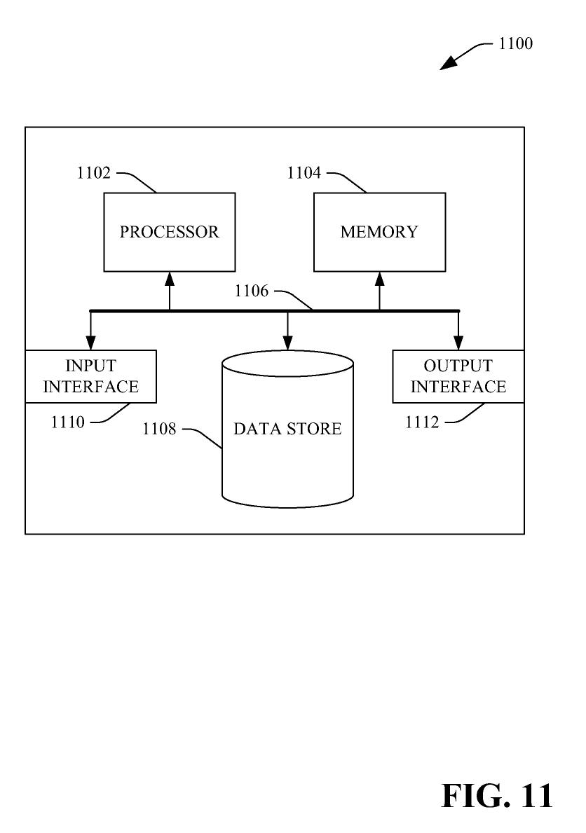

Now referring to FIG. 11, a high-level illustration of an example computing device 1100 that can be used in accordance with the systems and methodologies disclosed herein is provided. For instance, the computing device 1100 may be used in a system that supports automatically updating an information providing algorithm. In another example, at least a portion of the computing device 1100 may be used in a system that supports tracking geographic locations of a mobile computing device to ascertain whether a user has been affected by information displayed to such user. The computing device 1100 includes at least one processor 1102 that executes instructions that are stored in a memory 1104. The instructions may be, for instance, instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may also store search results provided to a user, travel directions provided to a user, advertisements provided to a user, geographic locations corresponding to one or more search results, etc.

The computing device 1100 additionally includes a data store 1108 that is accessible by the processor 1102 by way of the system bus 1106. The data store 1108 may include executable instructions, geographic locations corresponding to search results, travel directions, etc. The computing device 1100 also includes an input interface 1110 that allows external devices to communicate with the computing device 1100. For instance, the input interface 1110 may be used to receive instructions from an external computer device, receive queries from a personal computing device or mobile computing device, etc. The computing device 1100 also includes an output interface 1112 that interfaces the computing device 1100 with one or more external devices. For example, the computing device 1100 may display text, images, etc. by way of the output interface 1112.

Additionally, while illustrated as a single system, it is to be understood that the computing device 1100 may be a distributed system. Thus, for instance, several devices may be in communication by way of a network connection and may collectively perform tasks described as being performed by the computing device 1100.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method configured for execution in a mobile computing device comprising the following computer-executable acts:
using an information providing algorithm, providing data to a computer display device of a user, wherein the data pertains to a geographic location or travel route;
receiving an indication from a mobile computing device of the user that the user is travelling towards the geographic location, is proximate to the geographic location, has reached the geographic location, or diverted from the travel route; and
modifying the information providing algorithm based at least in part upon the received indication.

2. The method of claim 1, further comprising:
receiving a query issued by the user; and
providing the data to the display device in response to receipt of the query issued by the user.

3. The method of claim 1, wherein an Internet search engine comprises the one information providing algorithm, and wherein the data is a search result provided to the user.

4. The method of claim 1, wherein a mapping application comprises the information providing algorithm, and wherein the data is travel directions between two geographic points.

5. The method of claim 1, wherein an advertisement server comprises the information providing algorithm, and wherein the data is an advertisement.

6. The method of claim 1, wherein the data is a search result displayed to the user amongst a plurality of search results.

7. The method of claim 1, further comprising causing an advertisement to be provided to the mobile device upon receipt of the indication.

8. The method of claim 1, wherein the computer display device is located on the mobile device.

9. The method of claim 1, wherein the data pertains to a business, service, or product, and further comprising providing a request to the user to provide a review pertaining to the business, service, or product.

10. The method of claim 1, further comprising initiating an auction between prospective advertisers upon receipt of the indication.

11. The method of claim 1, wherein the data corresponds to a certain point in time, and further comprising causing second data to be displayed on the mobile device of the user if the indication is received outside a threshold window of time from the certain point in time.

12. The method of claim 11, wherein the second data indicates alternate locations pertaining to the first data.

13. The method of claim 11, wherein the second data indicates alternate points in time with respect to the first data.

14. The method of claim 1, wherein the indication is received in an anonymous manner.

15. The method of claim 1, wherein the indication is received after the mobile device is proximate to the geographic location for a threshold amount of time.

16. A system comprising the following computer-executable components:
an information provider component that uses at least one information providing algorithm to transmit data for display on a computer display screen of a user, wherein the data corresponds to a geographic location;
a receiver component that receives an indication from a mobile device of the user that the user is travelling towards, is proximate to, or has reached the geographic location; and
an updater component that causes the at least one information providing algorithm to be updated upon the receiver component receiving the indication.

17. The system of claim 16, wherein a search engine comprises the information provider component, and wherein the information provider component transmits the data upon receipt of a query from the user.

18. The system of claim 16, wherein the data is a search result displayed to the user amongst a plurality of search results.

19. The system of claim 16, further comprising an advertisement component that serves at least one advertisement to the mobile device of the user upon receiving the indication that the user has is travelling towards, is proximate to, or has reached the geographic location.

20. A computer-readable medium comprising instructions that, when executed by a processor, perform the following acts:
receiving a query from a user, wherein the user issues the query from a mobile computing device;
using at least one search algorithm, providing the user with search results responsive to receipt of the query, wherein at least one of the search results corresponds to a particular geographic location;
receiving an indication from the mobile device that the user has travelled to the geographic location; and
using the indication as feedback to update the at least one search algorithm.
